(19) United States
(12) Patent Application Publication
(10) Pub. No.: US 2022/0275647 A1
(43) Pub. Date: Sep. 1, 2022

(54) CONSTRUCTION SHEET

(71) Applicant: EWALD DÖRKEN AG, Herdecke (DE)

(72) Inventors: Thomas BACHON, Düsseldorf (DE); Uwe KAISER, Herdecke (DE); Norbert KLINGELHAGE, Wetter (DE); Jochen LIPPS, Hagen (DE); Ilias MOKANIS, Herdecke (DE); Umut MÜLLER, Hagen (DE); Henning SAND, Dortmund (DE)

(21) Appl. No.: 17/629,036

(22) PCT Filed: Aug. 14, 2020
(86) PCT No.: PCT/EP2020/072844

§ 371 Date: Jan. 21, 2022

(30) Foreign Application Priority Data
Aug. 28, 2019 (DE) 10 2019 006 069.5
Oct. 11, 2019 (DE) 10 2019 007 074.7

(51) Int. Cl. E04D 12/00; E04D 5/10

(52) U.S. Cl. CPC E04D 12/002; E04D 5/10

(57) ABSTRACT

The invention relates to a construction sheet, in particular sub-roof sheet (1), in particular intended for use as an underlay sheet, preferably formwork sheet, and/or roof seal sheet, and/or facade sheet, with at least one carrier layer (2) designed as fire protection layer and at least one further layer (3), wherein the further layer (3) is designed as a further fire protection layer.

The present invention relates to a construction sheet, especially a sub-roof sheet, in particular intended for use as an underlay sheet, preferably a formwork sheet, and/or a roof seal sheet, and/or a facade sheet.

In particular, the construction sheet can be used in the construction industry, preferably as a building envelope.

The primary object of a construction sheet, especially a sub-roof sheet, in particular a roof seal sheet and/or a formwork sheet, is to ensure rainproofing under the hard roofing for a roof and/or building. Sheets of the aforementioned type are used in the construction sector and especially have the object of protecting the interior of the building and/or roof structures not only from rain and moisture, but also from drifting snow and/or dust.

The sub-roof sheets are preferably used thereby on pitched roofs, for example on hipped roofs or domed roofs.

A formwork sheet lies especially on a formwork plane, wherein a flat construction is to be understood as a formwork sheet (also called formwork), which serves for cladding. Roof formwork is usually applied to the rafters.

The underlay sheet can be considered the enveloping surface of a building and is used for exterior sealing and/or windproofing.

Sub-roof sheets are usually used for an extended period of use, which can extend over several years or even decades. High demands are thereby placed on the sub-roof sheet for the period of use. The high requirements can be with regard to aging resistance, resistance to UV radiation, moisture and/or dust. The requirements for aging resistance result from the fact that the sub-roofing membrane is exposed to environmental influences such as temperature fluctuations. These environmental influences thereby have an accelerating effect on the natural aging process of the sub-roof sheet and possibly lead to a loss of the mechanical properties, especially the tensile strength and elongation at break.

The sub-roof sheets are exposed to outdoor weathering in humid conditions, which can accelerate the aging process in particular. This phase of outdoor weathering occurs when the sub-roof sheets have already been laid but the roof is not yet fully or only partially covered. Especially during this period, the sub-roof sheet is exposed to high loads due to incident UV intensity. At the same time, the primary object of the sub-roof sheet, i.e. its water-repellent and/or waterproof function, should continue to be ensured.

In the following, the terminology and/or the characterization “outside” and/or “from the outside” usually indicates that the side facing the weather and especially the side facing away from the roof structure is meant. Accordingly, the terminology “inside” and/or “from inside” usually refers to the inside of the building and/or the side facing the roof structure and away from the weathering side.

Roof constructions and/or roof systems are complex systems, which in particular consist of several building materials. In the event of a real risk of fire, these roof structures are exposed to high thermal stresses.

A fire attack can occur both from the inside—from within the building—and from the outside. Especially for fire attack on the roof exterior—on the outside of the sub-roof sheet—the sub-roof sheet is exposed to high thermal loads.

In the state of the art, the known construction sheets usually hold these high thermal loads only for a very short period of time. If a fire hazard occurs from the outside—for example, from a fire in a neighboring building and/or from fireworks falling on the roof area and/or from roof work with an open flame—the fire usually spreads to the inside of the building after a very short period of time, for example, between three to ten minutes. This poses a danger to the people present in the building. In the event of a fire, there is also an existential threat to industrial and commercial operations. Material damage can still be compensated, but death or damage to the health of the persons present in the building cannot.

Normally, the fire spreads over a large area very quickly also due to the possibility of quickly spreading to the interior of the building, so that neighboring buildings are also affected promptly.

Accordingly, roof systems represent a danger zone in the event of fire, especially since the roof structure can also collapse in the event of fire or “fuel” the fire further. Also, the chemical compounds (harmful gases) released in the event of a fire can lead to smoke poisoning of firefighting personnel and/or residents.

It is the object of the present invention to avoid the aforementioned disadvantages of the prior art or at least to substantially reduce them. Especially it is the object of the present invention to provide a construction sheet which improves fire protection.

The aforementioned object is solved according to the invention by a construction sheet, in particular a sub-roof sheet, in particular intended for use as a sub-roof sheet, preferably a formwork sheet, and/or a roof seal sheet, and/or a facade sheet, with at least one carrier layer designed as a fire protection layer and at least one further layer, wherein the further layer is designed as a further fire protection layer.

The design of the construction sheet according to the invention increases the fire protection. Ultimately, the construction sheet is designed in at least two parts and/or layers, wherein both the carrier layer and the further layer separate from the carrier layer are each designed as a fire protection layer. Preferably, both the carrier sheet and the further layer comprise a very good fire and flame resistance, so that the roof structure lying under the sub-roof sheet (for example the boarding or the roof truss) and/or the interior of the building is protected for a longer period of time, in particular at least 20 minutes, preferably at least 30 minutes, against the passage of flames into the interior of the building.

Hereinafter, the construction sheet will be referred to as a sub-roof sheet. However, according to the invention, it is understood that the explanations for the sub-roof sheet can also apply in the same way to the construction sheet, preferably the facade sheet.

The further layer is arranged especially on the outside of the sub-roof sheet. Alternatively, the further layer can also be arranged on the inside and/or facing the inside of the building.

By designing the sub-roof sheet according to the invention in two, in particular separate, fire protection layers, it can be achieved that the spread of a fire is made more difficult, so that it is possible for the occupants of the building to get to safety in the event of a fire.

It is precisely the effect of a fire from outside and/or a fire attack from outside that can be counteracted by the design of the sub-roof sheet according to the invention. As previously explained, fire effects from the outside can be triggered especially by a fire started by fire work on the roof surface—e.g. by carelessness when using open flames—or by a fire in the neighborhood. In the event of a fire in the neighborhood, the sub-roof sheet is exposed to flying flames and/or radiant heat. In the prior art, known sub-roof sheets cannot safely “repel” flying fires and/or sparks. According to the invention, it is especially made possible that the fire effects from the outside are at least substantially “controllable”. The “control” of the fire effects can thereby be made possible for a longer period of time, for example at least 10 minutes, preferably at least 20 minutes, even more preferably at least 30 minutes. More preferably, a fire flashover can be contained by the neighbor building.

But also a fire spillover from a fire inside the building can be counteracted by the sub-roof sheet according to the invention, especially in such a way that the fire does not spread directly to the roof structure and/or to neighboring buildings—at least for a certain period of time. In this way, collapse of the roof and/or the roof structure can also be prevented or at least delayed.

Furthermore, the sub-roof sheet according to the invention makes it possible to meet, especially exceed, the national legal requirements for a roof structure with regard to fire protection specifications.

In tests carried out, it was found in particular that the resistance to the aging process of the sub-roof sheet according to the invention can be improved by more than 10% compared with the sub-roof sheet known from the prior art. Especially the resistance to UV light and/or weathering was tested thereby. At the same time, it was possible to maintain the high level of waterproofing, and even especially to increase it by up to 15%.

Overall, the at least two-part design of the sub-roof sheet according to the invention into a carrier layer designed as a fire protection layer and into a further layer designed as a further fire protection layer can protect the life and limb of persons and property, wherein the safety of the general public is also increased.

In a particularly preferred embodiment of the present invention, it is provided that the sub-roof sheet and/or the carrier layer and/or the further layer is/are designed to be flame-retardant and/or non-combustible in accordance with DIN 4102-1 (as at: August 2019) and/or in accordance with EN 13501-1 (as at: August 2019).

The classification and/or rating of the fire behavior of the layers can be determined by standards. In DIN 4102-1, there is a classification of building material classes, wherein layers with low flammability are classified in building material class B1 and non-combustible layers are classified in building material classes A1 and A2. Especially the sub-roof sheet and/or the carrier layer and/or the further layer comprises the building material class—according to DIN 4102-1— B1 and/or A2. Building material class A2 provides that the respective layer is designed to be non-combustible with combustible components.

In the European standard EN 13501-1, a further subdivision of the fire behavior into “subclasses” can be found. There, a classification is made to the effect that the smoke development and the burning dripping or falling off are assessed. Thus, the additional requirement can be made that no smoke development and/or no burning dripping/falling off occurs. Depending on which requirements are met, there is a further separation in the Euro classes. The aforementioned standards also specify the test procedure for determining the fire classes.

Especially the sub-roof sheet and/or the carrier layer and/or the further layer fulfills the additional requirement(s) that no smoke development and/or no burning dripping/falling off occurs.

According to DIN 4102-1, non-combustible building materials are especially those building materials that comprise a melting point of at least 1000° C. Such a high melting point can ensure that non-combustible components do not start to burn in the event of a fire, which counteracts the spread of the fire.

Furthermore, in another preferred embodiment of the invention, it is provided that the sub-roof sheet and/or the carrier layer and/or the further layer is/are designed to be fire-retardant with a fire-resistance class of F30 and/or highly fire-retardant with a fire-resistance class of F60 in accordance with DIN 4102-2 (as of: August 2019) and/or in accordance with EN 13501-2 (as of: August 2019). Alternatively or additionally, it can be provided that the sub-roof sheet and/or the support layer and/or the further layer comprises/exhibit a fire resistance or a fire resistance class of Class A (Class-A burning brand) according to ASTM E 108, in particular according to ASTM E 108-17 (as at: August 2019).

Via the aforementioned fire resistance classes, it is provided for which period of time the fire penetration, especially into the interior of the building, can be delayed. Accordingly, the use of the sub-roof sheet on the upper side of the roof can enable such a roof construction that can lead to a delay in fire penetration in the event of a fire, especially in the event of fire exposure from the outside. This is particularly advantageous in view of the fact that a large number of combustible building materials are used inside the building.

Accordingly, the sub-roof sheet according to the invention can prevent flames from passing over, at least for a certain period of time. The fire resistance class F30 (30 minutes) and/or F60 (60 minutes) ultimately provides the time frame in which the respective layer and/or the sub-roofing sheet itself can provide the fire protection properties and “resist” the fire. Furthermore, the aforementioned standards especially regulate the test procedures in case of fire.

Ultimately, the aforementioned design of the sub-roof sheet and/or the carrier layer and/or further layer makes it possible to limit fire propagation. Delaying the fire propagation results in a time frame in which the fire can be detected, occupants can escape and/or emergency and rescue forces can arrive to rescue and extinguish the fire.

Preferably, the carrier layer comprises a textile sheet fabric and/or is designed as a textile sheet fabric. Especially the carrier layer comprises and/or consists of a glass fiber fabric, carbon fiber fabric, ceramic fiber fabric, silicon fiber fabric, polycarbon fiber fabric and/or metal fiber fabric. Also fabrics with mixed fibers of at least two of the aforementioned types of fabrics are possible, for example glass fibers and carbon fibers, ceramic fibers and metal fibers or any other combination of two or more types of fibers of the aforementioned types. Most preferably, the textile fabric is designed to be at least flame-retardant according to DIN 4102-1 and/or EN 13501-1.

Alternatively or additionally, it can be provided that the carrier layer comprises at least one nonwoven. The nonwoven can be designed as a textile fabric. The nonwoven may comprise and/or consist of mineral fibers, aramid fibers, thermoplastic fibers, preferably high-temperature thermoplastic fibers and/or fibers of thermally treated thermoplastics, glass wool fibers and/or rock wool fibers. In particular, the aforementioned fibers are flame retardant and/or non-combustible according to DIN 4102-1 and/or EN 13501-1.

It is also possible for the carrier layer to comprise and/or consist of glass fibers, carbon fibers and/or rock wool and/or be designed as a glass fiber mat and/or carbon fiber mat. Carbon fibers are understood to mean especially carbon fibers and/or carbon fibers.

In a further particularly preferred embodiment, it is provided that the carrier layer comprises, in particular oxidized, polyacrylonitrile fibers (PAN fibers) and/or consists thereof.

Preferably, the textile fabric and/or the nonwoven fabric of the carrier layer comprises such a weave and/or mesh size, in particular a close weave and/or mesh size, so that the carrier layer is designed in particular to be airtight and/or windproof and/or, in the event of fire, no “further” oxygen can be supplied to the fire, in particular via the carrier layer.

Furthermore, the carrier layer can also be designed as a substrate layer.

The above-mentioned advantageous design of the carrier layer enables in particular a high stability of the sub-roof sheet and thus also a stabilizing effect for the further layer. In particular, the further layer can be arranged directly at and/or on the carrier layer, wherein the carrier layer can ultimately serve as a carrier for the further layer. The advantageous design of the carrier layer as a textile sheet fabric and/or as a nonwoven ultimately enables an at least flame-retardant carrier layer to be provided as a fire protection layer, which can be used for arranging the further layer to increase the fire protection. Furthermore, the further layer can especially ensure rain resistance.

Furthermore, in an even more preferably embodiment, the further layer is designed as a coating. The coating can be applied to at least one side, preferably both sides, of the carrier layer, preferably directly. Alternatively or additionally, it can be provided that the further layer is designed as a coating layer.

Furthermore, the further layer can also be formed as an extruded layer, especially wherein the further layer has been extruded onto the carrier layer by means of an extrusion process.

In another particularly preferred embodiment, it is provided that the further layer has been manufactured in an extrusion process, in particular using a molten material, in particular wherein the further layer is and/or has been extruded onto the carrier layer.

Alternatively or additionally, it may be provided that the further layer comprises as material a thermoplastic, preferably thermoplastic polyurethane (TPU), and/or consists thereof. Particularly preferably, the thermoplastic material of the further layer is applied in an extrusion process, preferably to the carrier layer.

Accordingly, in a further particularly preferred embodiment, it is provided that the thermoplastic polyurethane has been applied to the carrier layer as an extruded-on layer.

In particular, the further layer is inseparably, preferably directly, connected to the carrier layer, preferably wherein the connection of the further layer to the carrier layer is achieved during and/or by application of the coating to the carrier layer, especially wherein the coating is dried.

Preferably, the coating can be dried in an oven after application.

Even more preferably, the further layer formed as a coating is manufactured on the basis of an acrylate dispersion, in particular an aqueous one. The especially aqueous acrylate dispersion can be spread and/or extruded onto the carrier layer. Spraying the in particular aqueous acrylate dispersion onto the carrier layer is also possible in principle.

Furthermore, in a further advantageous embodiment of the invention, the further layer formed as a coating comprises acrylates and/or consists thereof. Especially methacrylates, butyl acrylates, alklyl methacrylates, ethyl acrylates and/or polyacrylates can be provided as acrylates. In connection with the state of the invention, it has been found that in the case of an acrylate dispersion composed of acrylates of the aforementioned type, particularly advantageous effects can be achieved in terms of improving fire protection and preventing the spread of fire. At the same time, the further requirements of a sub-roof sheet, such as the provision of rain resistance, can be ensured.

The further layer can especially be designed as a barrier to protect against UV rays. The resistance to UV rays can preferably be increased by the further layer according to the invention by at least 10%, preferably at least 30%, compared to sub-roof sheets known from the prior art. In particular, such an increase in resistance to UV radiation results when the further layer is designed as a coating based in particular on an aqueous acrylate dispersion.

Most preferably, the further layer is designed to be unfoamed and/or free of hydrophobing agent additives. Alternatively or additionally, it can be provided that the further layer is designed to be diffusion-inhibiting and/or diffusion-barrier. Even more preferably, the unfoamed further layer is designed to be diffusion-blocking. Consequently, it is especially not necessary to add foaming agents to the further layer, nor is it necessary to foam the acrylate dispersion, which is especially aqueous, when it is applied to the carrier layer. Due to the formation of the further layer as a coating according to the invention, it is also possible to dispense with a hydrophobing agent layer, which is usually coated on the outside of the sub-roofing sheet in the prior art.

Alternatively or additionally, the further layer can be designed to be foamed and/or hydrophobic, especially to improve the weathering properties of the further layer.

Preferably, the further layer comprises filler particles, especially inorganic filler particles. Most preferably, the further layer is designed as a coating, wherein the filler particles can be enclosed and/or arranged in the, especially aqueous, acrylate dispersion. Preferably, non-combustible filler particles according to DIN 4102-1 and/or EN 13501-1 are provided. The filler particles can be mineral filler particles, preferably quartz grains and/or mineral grains. Most preferably, fine-grained sand and/or fine sand can be used as filler particles.

Alternatively or additionally, glass powder, glass beads and/or exfoliated graphite may be provided as filler particles. Most preferably, exfoliated graphite is provided as the material for the filler particles.

Exfoliated graphite is also referred to as expandable graphite. In addition, exfoliated graphite can be designed in such a way that heating the material causes expansion, preferably to a multiple of the initial volume, especially from a temperature of at least 200° C., preferably at least 150° C. Accordingly, exfoliated graphite is preferably suitable for flame retardancy. Thus, an intumescent layer can further be formed on the material surface by heating. In particular, this slows down the spread of fire and also counteracts the effects of fire that are most dangerous to humans, such as the formation of toxic gases and smoke.

The mineral and/or inorganic design of the filler particles can increase the component of the non-combustible constituents of the further layer, after which fire protection can be improved. By integrating the preferably inorganic filler particles, it can especially be achieved that the fire resistance class can be increased.

Especially a granular coating can be provided.

But also independently of the design of the further layer as a coating, it is particularly advantageous if the further layer comprises filler particles which are integrated into the further layer.

Alternatively or additionally, filler particles may be integrated in the carrier layer and/or in other layers of the sub-roof sheet, especially to increase the inorganic content of the respective layer. Particularly preferably, mineral filler particles, such as quartz grains and/or mineral grains, are incorporated in the carrier layer.

In another particularly preferred embodiment, the filler particles comprise at least a total proportion of 30% by weight, preferably at least 40% by weight, even more preferably at least 50% by weight and in particular at least 60% by weight, with particles having an average particle size of between 0.01 and 5 mm, preferably between 0.02 and 3 mm, even more preferably between 0.03 and 2 mm, preferably between 0.05 and 1 mm. Especially very fine-grained sand or exfoliated graphite is used as filler particles.

Preferably, the filler particles comprise at least 20% by weight of the further layer, preferably at least 30% by weight, further preferably at least 50% by weight. The above-mentioned information refers especially to the further layer in the state of use, in particular in a dried state.

In this context, it is understood preferably that also different materials can be used for the filler particles, in particular wherein at least one material type, preferably exfoliated graphite, can comprise a proportion of the total filler particles of at least 10% by weight, preferably at least 25% by weight, even more preferably at least 50% by weight. The other types of material may comprise mineral and/or inorganic fillers, especially barium sulfate and/or antimony trioxide.

Preferably, when different material types are used for the filler particles, at least one material type, in particular exfoliated graphite, may comprise a weight fraction of the further layer of at least 5% by weight, preferably at least 10% by weight, even more preferably at least 15% by weight and in particular of 17% by weight +/−10%. The above-mentioned information relates in particular to the further layer in the state of use, in particular in a dried state.

Preferably, at least one further portion of further filler particles is provided, wherein the further filler particles comprise a particle size which is larger than the average particle size of the filler particles.

It has been shown, especially in the development of the invention, that with such a particle size of the filler particles and/or with such a particle size distribution of the filler particles, the fire protection effect of the entire sub-roof sheet can be improved, preferably by at least 40%, in particular wherein the filler particles can be enclosed in the further layer formed as a coating.

Due to the especially fine filler particle grains, the further layer can be easily applied, in particular to the carrier layer.

Furthermore, the further layer preferably comprises at least one scattering layer. The scattering layer can be provided on the outside of the sub-roof sheet. It is particularly advantageous if the scattering layer is provided at and/or on and/or in the further layer formed as a coating. Especially, the scattering layer may have been manufactured by means of sanding. In the case of a sanding operation, it is provided that the surface is sprinkled with sprinkling material, in particular, preferably fine-grained, sand, after which an upper sprinkling layer results. Especially the scattering layer is arranged on and/or at the side of the sub-roof sheet facing the weathering side. Most preferably, the scattering layer may comprise the filler particles—already introduced with regard to their properties—or at least a portion of the filler particles.

Alternatively or additionally, the further layer may comprise filler particles, wherein at least one scattering layer formed by filler particles may also be provided. The filler particles integrated in the further layer may differ from the filler particles of the scattering layer and/or be at least substantially identical to them. Advantageously, the filler particles in the scattering layer comprise at least one of the advantageous features described earlier.

The scattering layer can be applied to the further layer, especially by scattering the filler particles onto the, especially moist and/or uncured, outer surface of the further layer. In this way, especially a connection between the filler particles of the scattering layer and the, especially aqueous, acrylate dispersion of the further layer in the form of a coating can be achieved.

In addition, the scattering layer is to be regarded in particular as a component of the further layer. Provision can thereby be made for the “remaining” further layer to merge into the scattering layer. The scattering layer can be designed to cover the entire surface or a part of the surface.

Preferably, the scattering layer can increase the proportion of inorganic constituents of the further layer. Most preferably, inorganic constituents are used in the scattering layer, for example mineral filler particles.

Preferably, the further layer comprises a proportion of at least 2% by weight, preferably at least 5% by weight, even more preferably between 10% by weight and 70% by weight, of filler particles. Alternatively or additionally, it may be provided that the scattering layer comprises a proportion of at least 20% by weight, preferably at least 30% by weight, further preferably between 35% to 100% by weight and preferably between 50% to 99% by weight, of filler particles.

In another advantageous embodiment, the layer thickness of the carrier layer is designed to be greater, preferably by at least 20%, further preferably by at least 50%, preferably between 65% and 200%, than the layer thickness of the further layer. In particular, material of the further layer can be saved compared to material of the carrier layer. The further layer, preferably in the form of a coating, can therefore be applied to the carrier layer as an at least substantially thin film, wherein the carrier layer can increase or ensure the stability of the further layer and ultimately also serve as a carrier for the further layer. Especially the mechanical properties of the sub-roof sheet, in particular the tensile strength and/or elongation at break, can be ensured by the carrier layer.

Alternatively, the layer thickness of the further layer can be designed to be greater, preferably by at least 20%, further preferably greater than 50%, preferably between 65% and 200% greater, than the layer thickness of the carrier layer. According to the invention, the aforementioned size ratio can improve fire protection in that the further layer formed as a fire protection layer comprises a higher proportion of the entire sub-roof sheet than the carrier layer. The further layer especially comprises better fire protection properties and/or a higher fire resistance class than the carrier layer. The increased proportion of the further layer in the sub-roof sheet can therefore especially ensure that the sub-roof sheet as a composite of layers comprises a very good flame resistance and/or a very good resistance to the propagation of a fire event.

In a further preferred embodiment, the carrier layer comprises grammage of between 20 and 2000 g/m², preferably between 30 and 800 g/m², even more preferably between 40 and 400 g/m². Especially, a grammage in the order of magnitude mentioned above results when the carrier layer is designed as a textile sheet fabric and/or as a nonwoven. It is particularly advantageous to select a nonwoven of this type that comprises the lowest possible grammage but can still ensure the mechanical properties of the sub-roof sheet while maintaining its fire protection capability.

In addition, in another particularly preferred embodiment, the further layer comprises a grammage of between 20 and 2000 g/m², preferably between 30 and 800 g/m², even more preferably between 40 and 400 g/m². Tests have shown that the above-mentioned grammage of the further layer can lead to a further improvement in the fire protection capability of the entire sub-roof sheet.

Preferably, the further layer is connected to the carrier layer, in particular directly. Thereby, the further layer can, for example, be sprayed, spread, extruded and/or laid onto the carrier layer. Furthermore, the further layer can be connected to the carrier layer—at least partially, preferably over the entire surface—by gluing, substance-bonding and/or form-fitting. Alternatively or additionally, it can be provided that the further layer is applied to the outside of the carrier layer on at least one side, in particular on the side facing the weather. Preferably, the further layer is applied to and/or arranged on both sides of the carrier layer. In a further embodiment, it can also be provided that the further layer is applied and/or arranged over part and/or all of the surface of at least one side of the carrier layer.

If the further layer is arranged on both sides of and/or on the carrier layer, especially the fire protection against the outside (fire effect from the outside) as well as against the inside (fire effect through the inside of the building) can be increased. In particular, an improved defense against a fire and/or against flames can thus be made possible.

In an even more preferably embodiment of the present invention, the further layer is designed as a metal layer, especially comprising aluminum, copper, silver, iron and/or platinum. Even more preferably, the further layer formed as a metal layer is diffusion-tight. The metal layer can be obtained via metallization of the carrier layer, for example via metal vapor deposition, and/or can be designed as metallization of the carrier layer. The metal layer can preferably be applied directly to the carrier layer. The metal layer can improve the fire behavior of the entire sub-roof sheet, since the metal and/or the metal alloy can comprise a high melting point, in particular above 800° C. Especially the further layer formed as a metal layer is non-combustible according to DIN 4102-1 and/or EN 13501-1.

Further, the sub-roof sheet and/or the further layer can be made slip-resistant on at least one outer side, in particular on the side facing the weather. Preferably, the slip-resistant formation is ensured in the dry and wet state, especially to prevent accidents during installation.

The slip-resistant surface of the sub-roof sheet and/or further layer can be roughened and/or rough and/or surface-structured and/or, in particular, have a grid-like surface structure. In particular, the rough and/or uneven surface structure can be generated by the scattering layer of the further layer and/or by the filler particles in the further layer. The rough surface of the sub-roofing sheet especially improves the coefficient of static friction in such a way that increased static friction results when walking on the surface of the sub-roofing sheet. The improved slip resistance of the sub-roof sheet can increase occupational safety during roofing work. During roofing work, a roofer moves and/or works on the surface of the sub-roof sheet. Accordingly, in addition to increasing the inorganic constituents, the scattering layer and/or the filler particles can improve the mechanical properties of the sub-roof sheet, especially the slip resistance.

Preferably, the sub-roof sheet comprises a low fire load with an energy content—also called calorific value—below 400 MJ/m². Preferably, the fire load is below 200 MJ/m², even more preferably between 1 to 100 MJ/m², even more preferably even more preferably between 5 to 80 MJ/m², and especially at least substantially less than or equal to 10.5 MJ/m². From the point of view of preventive fire protection, limiting the fire load of a roof structure is very useful. The fire load is thereby provided in megajoules per square meter (MJ/m²) and reflects the measured value of the building material and/or the component (in the present case the sub-roof sheet) in the installed state. This value is thereby to be held as low as possible.

More preferably, a vapor barrier with a low fire load is used, wherein the proportion of non-combustible components is as high as possible. By reducing the fire load, the spread of fire can be prevented or at least delayed in the event of a fire. If too high a fire load were available, the sub-roof sheet would “promote” the fire even further, especially after and/or during a fire. For example, with regard to vapor barriers, DIN 18234 (as of August 2019) stipulates that low fire load vapor barriers, especially those made of polyethylene or aluminum composite films, must comprise a calorific value or fire load of less than 10.5 MJ/m² and/or must not exceed the calorific value of 11.6 MJ/m² (fire load minimization). This is verified via a separate test. As a result of the low fire load, fire protection can be further improved.

In addition, in a further preferred embodiment, the carrier layer and/or the further layer and/or the sub-roof sheet is designed to be temperature-resistant and/or temperature-stable up to at least 450° C., preferably up to at least 600° C., even more preferably up to at least 800° C. The temperature-resistant design especially ensures that the sub-roof sheet and/or the further layer and/or the carrier layer does not melt up to this temperature and/or comprises a higher melting point. Consequently, the material does not start to burn, especially up to the aforementioned temperature limit. Consequently, the spread of fire can be prevented and/or contained for as long as possible.

Preferably, the sub-roof sheet comprises at least on one side, especially on both sides, on the outside—either on the outside facing the weather and/or on the inside facing the building interior—at least one adhesive layer for adhesive bonding, preferably for seam self-bonding, of neighboring sub-roof sheets. The adhesive layer is particularly advantageous with regard to the laying and connection of sub-roof sheets (rows of sub-roof sheets). When laying sub-roof sheets, it is intended that rows of sub-roof sheets be connected to one another directly adjacent to one another and/or resting on one another at least in certain areas to form a sealing plane. The adhesive layer enables adhesive bonding of the sub-roof sheets.

The adhesive layer integrated in the sub-roof sheet eliminates the need for additional adhesive bonding and/or an additional adhesive bonding agent which can be applied to the sub-roof sheet. In further embodiments, however, this can also be provided in principle.

The adhesive layer can, for example, be covered with a liner (especially a peel-off film). After the liner has been removed, the sub-roof sheets can be bonded. In particular, the sub-roof sheet rows are laid overlapping each other, resulting in a sealing layer of sub-roof sheets. An adhesive layer is thereby provided on at least one sub-roof sheet on the side facing the other sub-roof sheet.

In further embodiments, the adhesive layer can be designed over part of the surface, preferably in strip form, and/or be provided on at least one longitudinal edge of the sub-roof sheet. Most preferably, at least two longitudinal adhesive strips are provided on the sub-roof sheet.

There are thereby quite different possibilities for arranging an adhesive layer. For example, it is possible in principle for an adhesive layer to be provided at one longitudinal edge only. In an alternative embodiment, an adhesive layer is provided on a longitudinal edge on both the top and bottom sides. In another embodiment, an adhesive layer is provided on opposite longitudinal edges on the same sides in each case, while in another embodiment adhesive layers are provided on opposite longitudinal edges on opposite sides. It is also possible in principle for adhesive layers to be provided on the top and bottom sides of both longitudinal edges.

The adhesive layers can ultimately increase rain resistance and ensure wind-tightness of the connection between two neighboring sub-roof sheets in the edge area.

Alternatively or additionally, it can also be provided that the adhesive layer extends over at least the entire surface of at least one side of the sub-roof sheet, in particular on the outside and/or on the inside. In the case of adhesive bonding of neighboring sub-roof sheets, that area which is arranged overlapping another row of the sub-roof sheet can be “activated” for adhesive bonding, for example, by heating. The “remaining” adhesive area, on and/or adjacent to which no further sub-roof sheet is arranged, can especially comprise no adhesive properties in the “non-activated” state.

With regard to fire protection, it is advantageously provided that the adhesive layer is flame-retardant and/or fire-retardant. Preferably, the adhesive layer comprises a fire resistance class of F30 and/or is highly fire-retardant with a fire resistance class of F60 according to DIN 4102-2 (as of: August 2019) and/or EN 13501-2 (as of: Au-gust 2019). The aforementioned equipment and/or design of the adhesive layer improves the fire resistance of the entire sub-roof sheet. Preferably, the adhesive layer comprises flame-retardant and/or non-combustible components and/or is designed to be flame-retardant and/or non-combustible.

Preferably, the adhesive layer is designed as at least a flame-retardant and/or flammable self-adhesive pressure-sensitive adhesive layer.

In a further advantageous embodiment of the invention, the sub-roof sheet comprises a monitoring device and/or a monitoring device is associated to the sub-roof sheet. Thereby, the monitoring device can be integrated into the layer structure of the sub-roof sheet and/or designed as a separate device and associated to the sub-roof sheet.

In particular, the monitoring device further comprises at least one measuring device, preferably a smoke detector and/or a heat detector, for detecting a fire and/or a blaze. An alarm device of the monitoring device can be associated to the measuring device, wherein an alarm signal can be emitted via the alarm device, especially in case of fire.

After registration and/or detection of a fire and/or blaze, the monitoring device can be used to alert, in particular wirelessly, firefighting personnel and/or rescue personnel. This serves both to protect property, especially by preventing the spread of the fire, but also to protect life, since rescue personnel can be alerted via the monitoring device. In principle, it is also possible—alternatively or additionally—to provide for the emission of a warning tone via the alarm device, so that residents of the building can be informed of the occurrence of a fire at an early stage, especially in the event of fire exposure from outside.

In a further embodiment, an external extinguishing device can also be associated to the monitoring device in such a way that when a fire and/or a blaze is detected, the extinguishing device is activated in such a way that the fire can be extinguished, especially in the vicinity and/or at the place of origin. The extinguishing device can be used to extinguish the fire, for example by means of water, sand and/or extinguishing foam. This serves to further improve fire protection.

Particularly preferably, the carrier layer and/or the further layer and/or the sub-roof sheet is water-repellent and/or waterproof. Preferably, the sub-roof sheet and/or the further layer and/or the carrier layer comprises a water column of 0.5 to 50 m, preferably between 0.8 to 40 m, even more preferably between 0.9 to 30 m.

DIN 1928 (as of August 2019) and DIN 20811 (as of August 2019) should be consulted when assessing the water tightness of sub-roof sheets. These DIN standards show test conditions and/or determination procedures for determining water tightness. The waterproofness thereby decisively determines the use of the sub-roof sheet, since these are exposed to moisture and possibly driving rain, particularly on roofs exposed to the elements. All the aforementioned water columns correspond to a high resistance to the passage of water in accordance with DIN 20811.

In a particularly preferred embodiment, it is provided that the carrier layer and/or the further layer and/or the sub-roof sheet is designed as a vapor barrier, preferably water vapor retarding with a water vapor diffusion equivalent air layer thickness (sd value) of between 0.5 to 1500 m, preferably between 10 to 1500 m, even more preferably 100 to 1500 m. Alternatively or additionally, the support layer and/or the further layer and/or the sub-roof sheet may be designed as a vapor block, preferably a water vapor block with a water vapor diffusion-equivalent air layer thickness (sd value) of greater than 1500 m. The aforementioned design can be achieved especially via the further layer, which provides the diffusion density and/or the diffusion blocking properties.

The sd value characterizes the water vapor diffusion resistance. The vapor barrier can provide high moisture protection for an underground surface on which it is laid. The determination of the sd value is especially regulated by DIN 4108 (as of August 2019, Thermal Insulation in Building Construction) through the third part (climate-related moisture protection; requirement, calculation method and notes for planning and execution). DIN 4108-3 defines a sd value of less than 0.5 as the limit value for diffusion openness, and a sd value of 1500 m as the limit value for the vapor block. Accordingly, the sub-roof sheet is preferably designed to be at least vapor-barrier.

Alternatively or additionally, it can be provided that the carrier layer and/or the further layer and/or the sub-roof sheet is designed to be open to diffusion, preferably permeable to water vapor with a water vapor diffusion-equivalent air layer thickness (sd value) of between 0.01 and 1 m, preferably between 0.02 and 0.5 m, even more preferably between 0.03 and 0.3 m, and in particular at least substantially less than or equal to 5 cm. The aforementioned diffusion openness may allow moisture to escape from the interior of the building through the sub-roof sheet according to the invention.

It may also be envisaged that the further layer is designed as a vapor barrier and/or vapor block, wherein the carrier layer may be designed to be open to diffusion. Overall, this could result in a vapor barrier or vapor block design of the sub-roof sheet.

In a further embodiment of the invention, it is provided that the sub-roof sheet comprises at least one, preferably waterproof, functional layer. This embodiment is provided especially in combination with the water vapor-permeable design of the sub-roof sheet. The functional layer can be designed as a microporous membrane layer and/or as a monolithic membrane layer. The material for the functional layer can be a plastic, preferably based on polyolefinic plastic and/or thermoplastic polyurethane (TPU), and/or polyacrylate. The functional layer may be made of and/or comprise this plastic material.

A monolithic membrane layer is understood to mean especially a closed-cell and/or nonporous layer of a membrane. Monolithic membrane layers can especially ensure particularly good protection against driving rain while at the same time being open to diffusion.

Unlike conventional microporous membrane layers, moisture transport can take place actively along the molecular chains by diffusion.

Furthermore, a membrane layer is understood to be such a layer that comprises a selective permeability. Membranes can basically have different properties and can especially be designed as films or textiles. Membrane layers ensure, for example, when used as and/or in a sub-roof sheet, that the external influences of the weather do not have a damaging effect on the interior of the building.

Preferably, the functional layer formed as a monolithic membrane layer comprises as material plastic and/or synthetic resin and/or consists thereof. Furthermore, especially an elastomeric and/or a thermoplastic material is provided as material for the functional layer, preferably polyurethane plastic, especially thermoplastic polyurethane (TPU). Preferably, the functional layer is made of thermoplastic polyurethane. A TPU film comprises a high mechanical stability and is especially at least substantially resistant to weathering and/or environmental influences.

Thermoplastic material is especially intrinsically flame retardant and comprises a good long-term aging behavior, preferably for standard times of greater than or equal to 10 years.

The functional layer, which takes the form of a microporous membrane layer, is based in particular on polyolefins. Polyolefins are polymers manufactured from alkenes such as ethylene, polypropylene, 1-butene or isobutene by chain polymerization. Polyolefins are saturated hydrocarbons that make up the largest group of plastics in terms of volume. Furthermore, they belong to the group of semi-crystalline thermoplastics, wherein thermoplastics are especially easy to process due to a possible reversible deformation. In addition, polyolefins are characterized by good chemical resistance and particularly good electrical insulating properties.

Further, “microporous” in the context of the membrane layer means that the membrane layer comprises microscopically small holes and/or apertures that are designed large enough for water vapor molecules to diffuse through them. At the same time, however, these holes and/or openings are so small that larger water molecules, especially water molecules from raindrops, cannot pass through the membrane layer. In this case, the microporosity provides an indication that the sub-roof sheet is both waterproof and permeable to water vapor. The microporous structure of the membrane layer is created by a special pretreatment. Fillers, preferably calcium carbonates and especially chalk particles, are added to the plastic material to be processed. This material is subsequently extruded to manufacture the membrane layer and, in a further step, mono- or biaxially stretched at high temperatures and then cooled under tension. The stretching causes the extruded membrane layer to tear open, especially in the region of the fillers, resulting in microporosity.

In an even more preferably embodiment, at least one further carrier layer is provided which can be firmly connected, in particular glued, to the carrier layer and/or the further layer. The adhesive bonding can preferably be carried out by means of a reactive PU hot melt.

In this context, it is understood that according to the invention, the explanations regarding the carrier layer can also apply in the same way to the further carrier layer, without this requiring any further explicit mention.

Furthermore, according to a further preferred embodiment of the invention, it can be provided that the carrier layer can be coated with a, in particular thermoplastic, layer, preferably comprising and/or consisting of thermoplastic ether TPU (TPU denotes thermoplastic polyurethane). The coating with the layer can be provided completely or partially on at least one outer surface of the carrier layer.

In particular, the carrier layer is coated with the, in particular thermoplastic, layer prior to the application, in particular the coating, with the further layer.

Furthermore, the present invention relates to the use of a construction sheet, in particular a sub-roof sheet and/or a facade sheet, according to one of the preceding embodiments as a fire-retardant device in a roof structure and/or in a building, preferably for increasing the fire protection of a structure, preferably a pitched roof of the structure.

Especially, the sub-roof sheet is provided for fire retarding a fire originating and/or available on the outside of the roof. Accordingly, the sub-roof sheet according to the invention can delay, if not prevent, the effect of fire from the outside by virtue of its fire-retardant design, especially with respect to spreading to the interior of the building.

When using the sub-roof sheet according to the invention, the design of the sub-roof sheet according to the invention is shown to be particularly advantageous. To avoid unnecessary repetition, reference may be made to the above explanations.

Furthermore, it is understood that any intermediate intervals and individual values are included in the aforementioned intervals and range limits and are to be considered disclosed as essential to the invention, even if these intermediate intervals and individual values are not specifically provided.

Further features, advantages and possible applications of the present invention will be apparent from the description of examples of embodiments based on the drawing and the drawing itself. Thereby, all described and/or pictorially depicted features constitute the subject matter of the present invention, either individually or in any combination, irrespective of their summary in the claims or their reference back.

It shows:

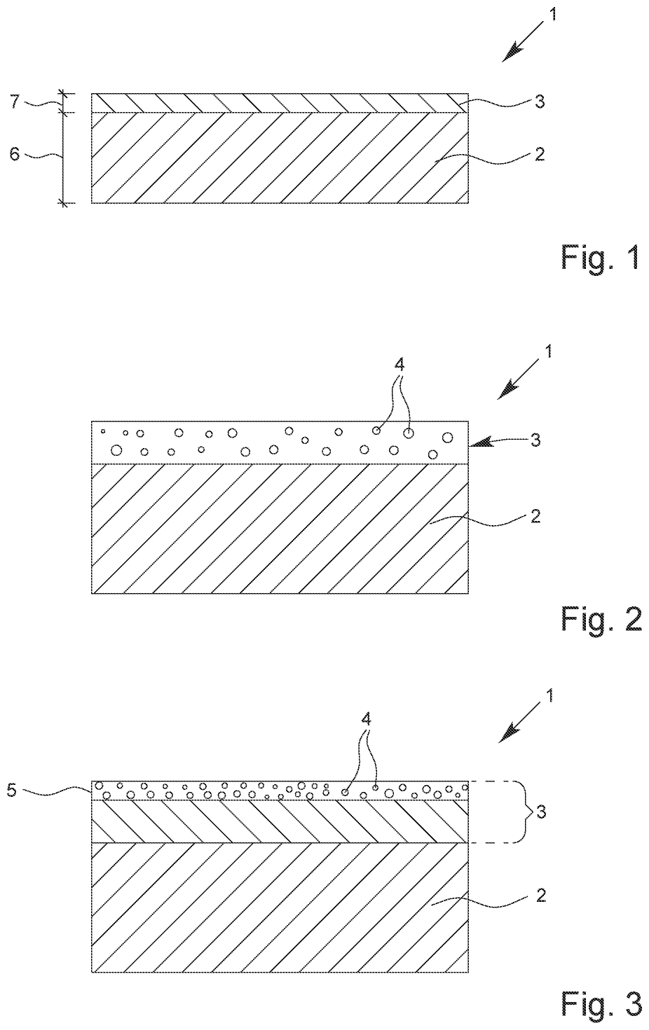

FIG. 1 a schematic cross-sectional view of a sub-roof sheet according to the invention,

FIG. 2 a schematic cross-sectional view of a further embodiment of a sub-roof sheet according to the invention,

FIG. 3 a schematic cross-sectional view of a further embodiment of a sub-roof sheet according to the invention,

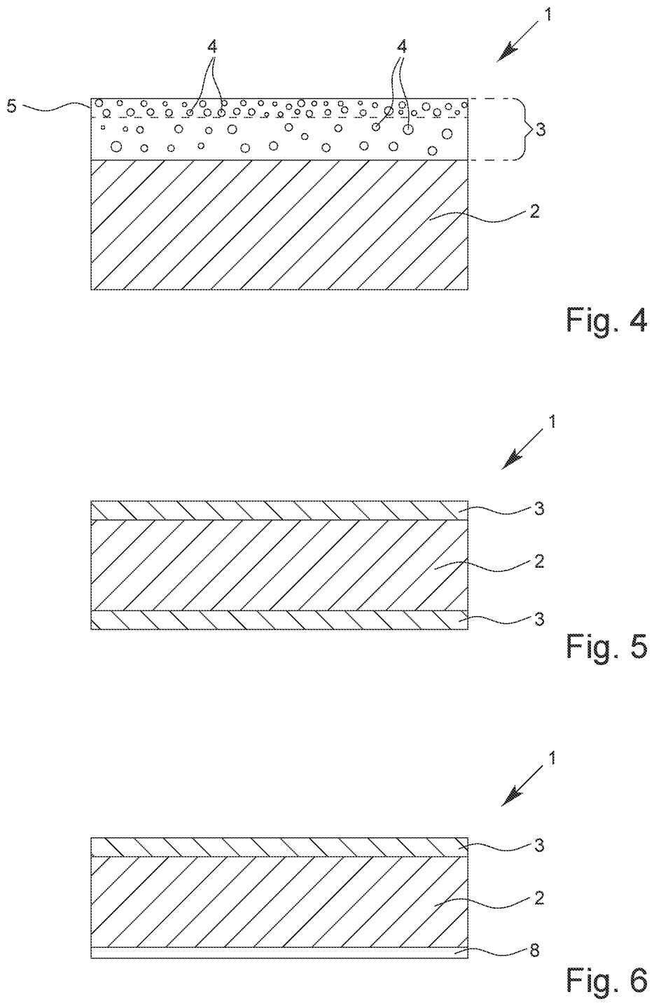

FIG. 4 a schematic cross-sectional view of a further embodiment of a sub-roof sheet according to the invention,

FIG. 5 a schematic cross-sectional view of a further embodiment of a sub-roof sheet according to the invention,

FIG. 6 a schematic cross-sectional view of a further embodiment of a sub-roof sheet according to the invention,

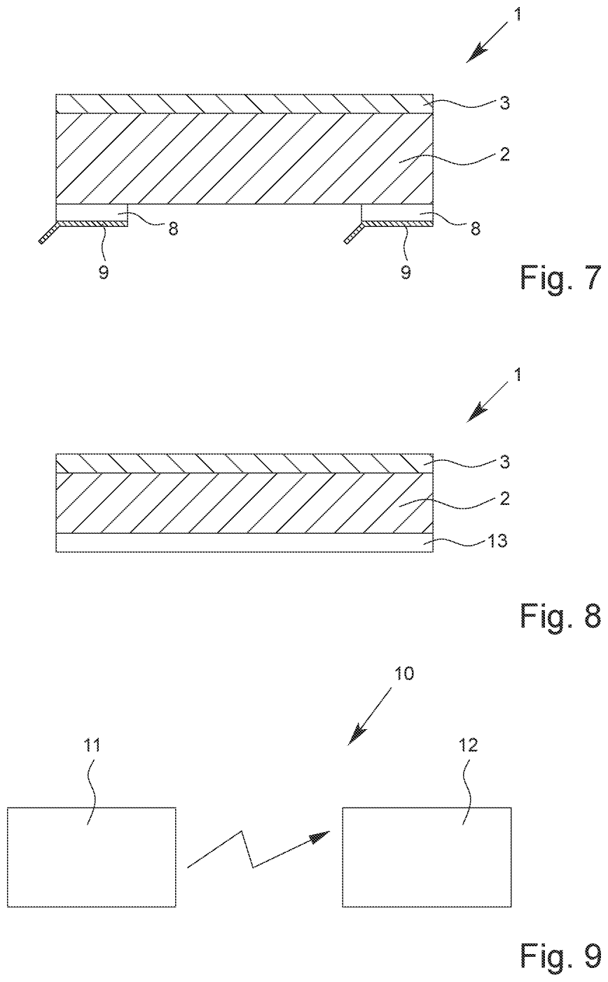

FIG. 7 a schematic cross-sectional view of a further embodiment of a sub-roof sheet according to the invention,

FIG. 8 a schematic cross-sectional view of a further embodiment of a sub-roof sheet according to the invention,

FIG. 9 a schematic illustration of a monitoring device according to the invention,

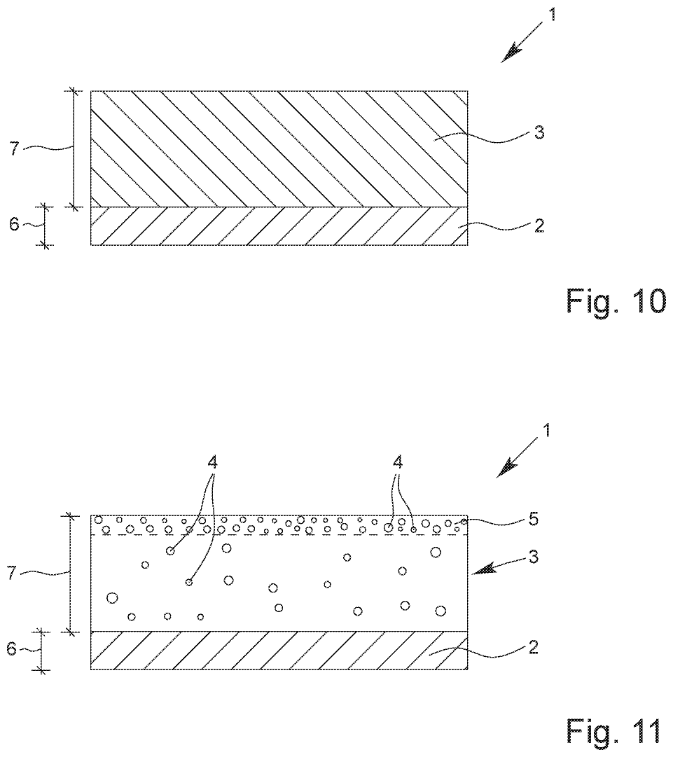

FIG. 10 a schematic cross-sectional view of a further embodiment of a sub-roof sheet according to the invention, and

FIG. 11 a schematic cross-sectional view of a further embodiment of a sub-roof sheet according to the invention.

The description of the figures refers to a sub-roof sheet 1. However, according to the invention, it is understood that the explanations for the sub-roof sheet 1 can also apply in the same way to a construction sheet, preferably a facade sheet.

FIG. 1 shows a sub-roof sheet 1 with at least one carrier layer 2 designed as a fire protection layer and at least one further layer 3, wherein the further layer 3 is designed as a further fire protection layer.

It is not shown that the sub-roof sheet 1 can also comprise a plurality of carrier layers 2.

FIG. 5 shows that the sub-roof sheet 1 can comprise a plurality—in the embodiment shown, two—of further layers 3.

In the case of a plurality of further layers 3, it may be envisaged that the further layers 3 are identical in construction or are designed differently from one another.

In the state of use, the sub-roof sheet 1 is arranged especially on and/or in the roof structure in such a way that preferably the further layer 3 is directed outwardly and/or faces the weather. The carrier layer 2 can thereby face the inside of the building.

The further layer 3 especially ensures fire protection, wherein fire effects from outside can be delayed. A design of the further layer 3 as a fire protection layer is to be understood in such a way that the further layer 3, but also preferably the carrier layer 2, is used to increase the fire protection and can further lead to a delay of the fire propagation and/or the transmission of the fire in case of fire.

It is not shown that the sub-roof sheet 1 is intended for use as a underlay sheet, preferably a formwork sheet, and/or a roof seal sheet.

In the embodiment shown in FIG. 1, the sub-roof sheet 1 and the further layer 3 are designed to be flame-retardant in accordance with DIN 4102-1 and EN 13501-1. In other embodiments, the carrier layer 2 may also be flame-retardant and/or non-combustible in accordance with the aforementioned standards. FIG. 2 shows that the further layer 3 is designed as a non-combustible layer, wherein it comprises building material class A2 according to DIN 4102-1.

The sub-roof sheet 1 shown in FIG. 2 is fire-retardant with a fire resistance class of F30 in accordance with DIN 4102-2 and EN 13501-2.

The sub-roof sheet 1 shown in FIG. 4 is designed with the carrier layer 2 and the further layer 3 to be highly fire-retardant with a fire resistance class of F60 in accordance with

DIN 4102-2 and EN 13501-2.

The sub-roof sheet 1 shown in FIG. 3 in turn comprises a Class A fire resistance according to ASTM E108, especially according to ASTM E108-17. In further embodiments, the carrier layer 2 and/or the further layer 3 can be fire-retardant with a fire resistance class of F30 or highly fire-retardant with a fire resistance class of F60.

The carrier layer 2 shown in FIG. 1 is designed as a textile fabric. In further embodiments, the carrier layer 2 may comprise a textile fabric. The textile sheet fabric may be composed of glass fiber fabric, carbon fiber fabric, ceramic fiber fabric, silicon fiber fabric, polycarbon fiber fabric and/or metal fiber fabric. Especially, the material of the carrier layer 2 is selected such that the carrier layer 2 is designed to be flame-retardant and/or non-combustible and/or fire-retardant and/or highly fire-retardant.

In the embodiment shown in FIG. 2, it is provided that the carrier layer 2 comprises at least one nonwoven. The nonwoven may comprise and/or consist of mineral fibers, aramid fibers, thermoplastic fibers and/or glass and/or rock wool fibers. Thermoplastic fibers can especially be high-temperature thermoplastic fibers and/or fibers made of thermally treated thermoplastics.

The carrier layer 2 shown in FIG. 3 is designed as a glass fiber mat.

In further embodiments, the carrier layer 2 may comprise glass fibers, carbon fibers and/or rock wool and/or be designed as a carbon fiber mat.

Especially, in even more preferably embodiments, it may be provided that the carrier layer 2 comprises and/or consists of polyacrylonitrile fibers (PAN fibers), in particular oxidized polyacrylonitrile fibers.

In the embodiment shown in FIG. 1, the further layer 3 is designed as a coating. In the embodiment shown in FIG. 1, the coating is coated on one side of the carrier layer 2.

It is not shown that the further layer 3 is designed as a coating layer.

FIG. 5 shows that the further layer 3 formed as a coating is coated on both sides of the carrier layer 2.

The further layer 3 formed as a coating can be manufactured on the basis of an acrylate dispersion, especially an aqueous one. Especially the acrylate dispersion can comprise acrylates, in particular methacrylates, butyl acrylates, alklyl methacrylates, ethyl acrylates and/or polyacrylates and/or consist thereof.

It is not shown that the further layer 3 is designed to be unfoamed and/or free of hydrophobing agent additives (free of an additional hydrophobing agent layer).

The further layer 3 shown in FIG. 1 is designed to be diffusion-barrier.

FIG. 2 shows that a diffusion-blocking further layer 3 is provided.

FIG. 2 further shows that the further layer 3, which is designed as a coating in the example shown, comprises filler particles 4. Especially inorganic filler particles 4 are provided. Mineral filler particles 4, such as quartz grains and/or mineral grains, can be used as filler particles 4.

Not shown is that the filler particles 4 comprise at least a proportion of 30% by weight, preferably of at least 40% by weight, even more preferably of at least 50% by weight, in particular of at least 60% by weight, with particles of an average particle size or particle size between 0.01 and 5 mm. In further embodiments, the particle size may be between 0.05 to 1 mm. Especially wherein a further proportion of further particles (filler particles 4) is provided, wherein the further particles of the filler particles 4 comprise a particle size larger than the mean particle size of the particles 4.

For example, fine sand and/or very fine-grained sand can be used as filler particles 4.

It is not shown that in an even more preferably embodiment exfoliated graphite is provided as material for the filler particles 4 and/or the filler particles 4 comprise or consist of exfoliated graphite.

FIG. 3 shows that the further layer 3 comprises a scattering layer 5. In the embodiment shown, the scattering layer 5 comprises filler particles 4. The further layer 3 can merge directly into the scattering layer 5. In the embodiment shown, the scattering layer 5 has been manufactured by a sprinkling of the further layer 3. Inorganic filler particles 4, especially mineral filler particles 4, can be used as filler particles 4. Especially quartz grains and/or mineral grains are provided as filler particles 4 of the scattering layer 5.

It is not shown that the scattering layer 5 has been manufactured by scattering the filler particles 4 onto the, especially moist and/or uncured, outer surface of the further layer 3.

FIG. 4 shows that the filler particles 4 are provided in the scattering layer 5. Further filler particles 4 are provided in the further layer 3, which is designed as a coating and has been manufactured on the basis of an especially aqueous acrylate dispersion. The scattering layer 4 may thereby have been manufactured by sanding the further layer 3, wherein the coating of the further layer 3 may already have comprised the filler particles 4 during the application to the carrier layer 2. Thus, the filler particles 4 of the further layer 3 may be provided not only in the scattering layer 5, but also in the layer structure of the further layer 3.

In the embodiments according to FIGS. 1 to 6, it is provided that the layer thickness 6 of the carrier layer 2 is designed to be greater than the layer thickness 7 of the further layer 3. Especially the layer thickness 6 of the carrier layer 2 can be designed to be at least 20%, in particular between 65% and 200%, greater than the layer thickness 7 of the further layer 3.

FIGS. 10 and 11 show that the layer thickness 6 of the carrier layer 2 is designed to be smaller than the layer thickness 7 of the further layer 3. Especially the layer thickness 7 of the further layer 3 can be designed larger than the layer thickness 6 of the carrier layer 2 by at least 20%, in particular between 65% and 200%.

FIG. 10 corresponds in particular to the embodiment shown in FIG. 1, wherein a change in the layer thicknesses 6, 7 is provided opposite thereto. FIG. 11 corresponds at least essentially to the embodiment shown in FIG. 4, wherein the ratio of the layer thicknesses 6, 7 is also designed differently.

It is not shown that the carrier layer 2 comprises a grammage between 20 and 2000 g/m², in particular between 40 and 400 g/m².

In the embodiments shown, it is provided that the further layer 3 is directly connected to the carrier layer 2. The connection of the carrier layer 2 to the further layer 3 may involve adhesive bonding and/or a form-fit connection. It is not shown that the further layer 3 is only indirectly connected to the carrier layer 2, wherein other (separate) layers may be arranged between the carrier layer 2 and the further layer 3.

In the embodiments shown, it is further provided that the further layer 3 is applied over the entire surface of the carrier layer 2. It is not shown that the further layer 3 can be applied over part of the surface of the carrier layer 2 and/or arranged thereon. The further layer 3 can be applied to the outside of the carrier layer 2.

Furthermore, it is not shown that the further layer 3 is designed as a metal layer, in particular a diffusion-tight metal layer. The metal layer may have been manufactured by metallizing the carrier layer 2 by means of metal vapor deposition, wherein the metal layer can be applied directly to the carrier layer 2.

In the embodiment shown in FIGS. 3 and 4, the sub-roof sheet 1 and the further layer 3 are designed to be slip-resistant on at least one outer side. The slip-resistant surface of the under-roofing sheet 1 and the further layer 3 can be designed to be rough, wherein the uneven surface structure which causes the roughness can be produced by the scattering layer 5 and the filler particles 4. Especially the coating (scattering layer 5) of the further layer 3 causes a rough surface of the further layer 3.

In the embodiment shown in FIG. 2, it is envisaged that the sub-roof sheet 1 comprises a low fire load with an energy content (calorific value) of less than 400 MJ/m². Especially the sub-roof sheet 1 comprises an energy content of less than or equal to 10.5 MJ/m². The aforementioned low calorific value results especially when the sub-roof sheet 1 is designed as a vapor barrier and/or vapor block.

Especially, the carrier layer 2 and/or the further layer 3 and/or the sub-roof sheet 1 can be temperature-resistant or temperature-stable up to at least 450° C., in particular up to at least 800° C. In the embodiments shown, the sub-roof sheet 1 is temperature-stable up to at least 450° C. Up to this temperature limit, there is especially no essential change in the sub-roof sheet 1 due to the thermal load, wherein the sub-roof sheet 1 is provided for flame retardancy.

It is not shown that the sub-roof sheet 1 is designed to be resistant to treading, especially by means of at least one inorganic and/or organic lattice and/or fabric, and/or to tear propagation. A tear propagation resistance of the sub-roof sheet 1 can be ensured by a preferably reinforced foil layer, in particular comprising a vapor and/or wind block and/or metal and/or plastic and/or consisting thereof.

FIG. 6 shows that the sub-roof sheet 1 comprises an adhesive layer 8. In the embodiment shown in FIG. 6, it is envisaged that the adhesive layer 8 is applied on one side to the inner side of the sub-roof sheet 1 facing the interior of the building. Arrangement of the adhesive layer 8 on both sides is not shown. The adhesive layer 8 is provided for adhesive bonding, preferably seam self-adhesion, of neighboring sub-roof sheets 1. FIG. 7 shows that the adhesive layer 8 is formed over part of the surface. In the embodiment shown in FIG. 7, the adhesive layer 8 is arranged in strips along the longitudinal edge of the sub-roof sheet 1. Furthermore, the adhesive layer 8 is covered with a liner 9 (peel-off film) which can be removed, especially partially, for adhesive bonding.

In the embodiment shown in FIG. 6, it is provided that the adhesive layer 8 is provided at least substantially over the entire surface of the sub-roof sheet 1. In the embodiment shown in FIG. 6, it may be provided that the adhesive layer 8 must first be “activated” for adhesive bonding. Activation of the adhesive layer 8 can take place, for example, via the action of heat and/or warmth.

In the case of the adhesive layer 8 shown in FIG. 6, it is provided that it is flame-retardant and/or fire-retardant in accordance with DIN 4102-2 and EN 13501-2. Especially the adhesive layer 8 can comprise a fire resistance class of F30 and/or F60 (highly fire retardant). Accordingly, the adhesive layer 8 can also be designed as a further fire protection layer of the sub-roof sheet 1.

FIG. 9 shows a monitoring device 10. The monitoring device 10 can be integrated into the sub-roof sheet 1 and/or associated to the sub-roof sheet 1 as a separate device and/or as a device with separate means and means integrated into the sheet 1. In FIG. 9, it is shown schematically that a measuring device 11 of the monitoring device is connected to an alarm device 12. Especially a wireless connection for information exchange between the measuring device 11 and the alarm device 12 can be provided.

The alarm device 12 may serve to emit a signal tone. Furthermore, a warning signal can alternatively or additionally be transmitted via the alarm device 12, in particular to firefighters, emergency personnel and/or rescue personnel. Preferably, such a transmission is wireless.

The measuring device 11 can, for example, be integrated and/or arranged on and/or in the sub-roof sheet 1. The measuring device 11 can be designed as a smoke detector and/or heat detector. Thereby the measuring device 11 serves for the detection of a fire and/or a blaze.

Accordingly, the monitoring device 10 serves to further increase fire protection. Until the arrival of emergency services, especially the design of the sub-roof sheet 1 according to the invention can prevent further conduction of the fire, which acts in particular on the outside and/or from the outside.

In the embodiments shown, the sub-roof sheet 1 is designed to be water-repellent, especially waterproof. Preferably, the sub-roof sheet 1 comprises a water column of between 0.8 and 40 m, preferably between 0.9 and 30 m. Especially, the water-repellent and/or waterproof properties of the sub-roof sheet 1 are provided by the further layer 3. The carrier layer 2 can—but need not—be designed to be water-permeable.

In the embodiment shown in FIG. 2, the further layer 3 and the sub-roof sheet 1 (as a whole) are designed as a vapor barrier with a water vapor diffusion-equivalent air layer thickness (sd value) of between 0.5 and 1,500 m.

The sub-roof sheet 1 shown in FIG. 6, but also in FIG. 1, is designed as a vapor block with a water vapor diffusion equivalent air layer thickness (sd value) of greater than 1500 m. The water vapor retarding and/or water vapor blocking property of the sub-roof sheet 1 can also be achieved by designing the further layer 3 and/or the carrier layer 2.

It is not shown that the carrier layer 2 and/or the further layer 3 and/or the sub-roof sheet 1 is designed to be open to diffusion, preferably permeable to water vapor, with a water vapor diffusion-equivalent air layer thickness (sd value) of between 0.01 to 1 m, in particular between 0.03 to 0.3 m.

FIG. 8 shows that the sub-roof sheet 1 comprises at least one functional layer 13. The functional layer 13 can be designed to be waterproof.

Furthermore, in other embodiments, the functional layer 13 can be designed to be water-vapor-barrier, water-vapor-blocking and/or water-vapor-permeable—depending on the desired embodiment of the sub-roof sheet 1.

It is not shown that the functional layer 13 is designed as a microporous membrane layer and/or as a monolithic membrane layer. Also not shown in the embodiments shown is a multi-part structure of the functional layer 13 and/or a plurality of functional layers 13.

Especially, the functional layer 13 may comprise as material a plastic, preferably polyolefinic plastic-based and/or thermoplastic polyurethane (TPU), and/or consist thereof

Finally, it is not shown that the sub-roof sheet 1 according to any of the embodiments described earlier can be used as a fire-retardant device in a roof structure and/or in a building. A use in this regard may serve especially to increase the fire protection of a structure. Especially, the sub-roof sheet 1 is used in a pitched roof of the structure. The sub-roof sheet 1 may be provided for fire retardation of a fire originating and/or available on the roof on the outside—fire action from the outside.

The flame-retardant properties of the sub-roof sheet 1 can especially prevent and/or avoid the spread of fire in case of fire.

Execution Examples

Three examples of embodiments for producing a construction sheet according to the invention, especially a sub-roof sheet and/or facade sheet, and/or the construction sheet according to the invention, especially a sub-roof sheet and/or facade sheet, are provided below.

### 1. Execution Example

On a coating line, a carrier layer, in particular a nonwoven, preferably comprising or consisting of oxidized polyacrylonitrile fibers, is coated with a further layer, in particular an aqueous coating composition of the further layer, and/or the carrier layer is fed to the coating line together with the further layer, in particular wherein the further layer is coated onto the carrier layer.

The carrier layer especially comprises a grammage of 250 g/m²+/−10%.

Afterwards, the further layer, in particular the layer composite of carrier layer and further layer, can be dried at least substantially completely, preferably in a continuous drying oven.

The coating weight of the further layer, especially of the aqueous compound, is thereby 250 g/m²+/−10%.

The further layer, especially the coating compound, contains an acrylate dispersion, 15% by weight +/−10% barium sulfate, 18% by weight exfoliated graphite +/−10% and 5% by weight antimony trioxide +/−10% as inorganic fillers.

The construction sheet is thereby not foamed and not hydrophobized.

### 2. Execution Example

In a first step, a carrier layer, in particular a PET nonwoven, preferably with a grammage of 80 g/m²+/−10%, is coated with a further layer, in particular an aqueous coating composition, and/or the carrier layer is fed to the coating system together with the further layer, especially wherein the further layer is coated onto the carrier layer.

Afterwards, the further layer, in particular the layer composite of carrier layer and further layer, can be dried at least substantially completely, preferably in a continuous drying oven.

The coating weight of the further layer, especially of the aqueous compound, is thereby 200 g/m²+/−10%.

The further layer, in particular the coating composition, contains an acrylate dispersion, 15 wt. %+/−10% barium sulfate and 18 wt. %+/−10% exfoliated graphite as inorganic fillers.

The further layer, especially the coating compound, also contains foaming aids and is preferably foamed by air before coating. After coating, the further layer is especially hydrophobized.

In a second step, the construction sheet obtained in the first step is glued and/or substance-bonded to a further carrier layer, in particular a nonwoven, preferably of oxidized polyacrylonitrile fibers, by means of an adhesive agent, in particular a reactive PU hot melt, on a laminating line.

The additional carrier layer may comprise a basis weight of 250 g/m²+/−10%.

### 3. Execution Example

In a first step, a carrier layer, especially a PET nonwoven, is coated with a thermoplastic layer, especially comprising a thermoplastic ether TPU, on an extrusion coating line.

The carrier layer comprises a grammage of 80 g/m²+/−10%. The thermoplastic layer comprises a coating weight of 30 g/m²+/−10%.

In a second step, the sheet and/or layer composite obtained in the first operation is coated with a further layer, especially an aqueous coating composition, and/or the carrier layer and/or the thermoplastic layer is fed together with the further layer to the coating system, in particular wherein the further layer is coated onto the carrier layer and/or the thermoplastic layer.

Afterwards, the further layer, in particular the layer composite comprising carrier layer, thermoplastic layer and further layer, can be dried at least substantially completely, preferably in a continuous drying oven.

The coating weight of the further layer, especially of the aqueous composition, is thereby 200 g/m²+/−10%.

The further layer, in particular the coating composition, contains an acrylate dispersion, 15 wt. %+/−10% barium sulfate and 18 wt. %+/−10% exfoliated graphite.

The further layer, in particular the coating compound, also contains foaming aids and is foamed, in particular before coating, preferably by means of air. Hydrophobing is especially dispensed with.

In a third step, the sheet obtained in the second step is glued and/or substance-bonded to a further carrier layer, in particular a nonwoven, preferably of oxidized polyacrylonitrile fibers, by means of an adhesive agent, in particular a reactive PU hot melt.

The other carrier layer may comprise a grammage of 250 g/m²+/−10%.

### LIST OF REFERENCE SIGNS

1 Sub-roof sheet
2 Carrier layer
3 Further layer
4 Filler particles
5 Scattering layer
6 Layer thickness of 2
7 Layer thickness of 3
8 Adhesive layer
9 Liner
10 Monitoring device
11 Measuring device
12 Alarm device
13 Functional layer

1. A construction sheet, in particular sub-roof sheet, in particular intended for use as an underlay sheet, preferably formwork sheet, and/or roof seal sheet, and/or facade sheet, with at least one carrier layer designed as fire protection layer and at least one further layer, wherein the further layer is designed as a further fire protection layer.

2. The construction sheet according to claim 1, wherein the construction sheet and/or the carrier layer and/or the further layer is designed to be flame-retardant and/or non-combustible according to DIN 4102-1 (as of August 2019) and/or according to EN 13501-1(as of August 2019), and/or
in that the construction sheet and/or the carrier layer and/or the further layer is fire-retardant with a fire resistance class of F30 and/or highly fire-retardant with a fire resistance class of F60 according to DIN 4102-2 and/or according to EN 13501-2 (as of August 2019) and/or comprises a fire resistance of Class A according to ASTM E108, especially ASTM E108-17 (as of August 2019).

3. The construction according to claim 1, wherein the carrier layer comprises a textile sheet fabric, especially wherein the carrier layer comprises and/or consists of a glass fiber fabric, carbon fiber fabric, ceramic fiber fabric, silicon fiber fabric, polycarbon fiber fabric and/or metal fiber fabric, and/or
in that the carrier layer comprises at least one nonwoven, wherein the nonwoven comprises and/or consists of mineral fibers, aramid fibers, thermoplastic fibers, preferably high-temperature thermoplastic fibers and/or fibers made of thermally treated thermoplastics, glass fibers and/or rock wool fibers, and/or
in that the carrier layer comprises glass fibers, carbon fibers and/or rock wool and/or consists thereof and/or is designed as a glass fiber mat and/or carbon fiber mat, and/or
in that the carrier layer comprises, in particular oxidized, polyacrylonitrile fibers and/or consists thereof.

4. The construction sheet according to claim 1, wherein the further layer is designed as a coating, in particular wherein the coating is applied to the carrier layer at least on one side, preferably on both sides, and/or wherein the further layer is designed as a lacquer layer and/or as an extruded layer.

5. The construction sheet according to claim 1, wherein the further layer formed as a coating is manufactured on the basis of an, especially aqueous, acrylate dispersion and/or
in that the further layer formed as a coating comprises acrylates, especially methacrylates, butyl acrylates, alklyl methacrylates, ethyl acrylates and/or poly acrylates, and/or consists thereof,
in particular wherein the further layer is designed to be unfoamed and/or free from hydrophobic additives and/or is designed to be diffusion-retardant and/or diffusion-barrier.

6. The construction sheet according to claim 1, wherein the further layer comprises filler particles, especially inorganic filler particles,
in particular wherein the filler particles are mineral filler particles, preferably quartz grains and/or mineral grains, and/or in particular wherein the filler particles comprise exfoliated graphite as material and/or consist thereof and/or in particular wherein
the filler particles comprise at least a proportion of at least 30% by weight, preferably at least 40% by weight, even more preferably at least 50% by weight and in particular of at least 60% by weight %, with particles of an average particle size and/or particle size between 0.01 and 5 mm, preferably between 0.02 and 3 mm, further preferably between 0.03 and 2 mm, preferably between 0.05 and 1 mm, in particular wherein at least one further proportion of further particles is provided, wherein the further particles comprise a particle size which is larger than the average particle size of the particles.

7. The construction sheet according to claim 1, wherein the further layer comprises a scattering layer, preferably by means of a sanding, especially wherein the scattering layer comprises the filler particles and/or the scattering layer has been manufactured on the further layer, especially by scattering the filler particles on the, especially moist and/or uncured, outer surface of the further layer.

8. The construction sheet according to claim 1, wherein the layer thickness of the carrier layer is designed to be greater, preferably greater than 20%, even more preferably greater than 50%, even more preferably between 65% to 200% greater, than the layer thickness of the further layer, or
in that the layer thickness of the further layer is greater, preferably greater than 20%, even more preferably greater than 50%, even more preferably between 65% and 200% greater, than the layer thickness of the carrier layer.

9. The construction sheet according to claim 1, wherein the further layer is connected, in particular glued and/or positively bonded, to the carrier layer, preferably directly, and/or in that the further layer is applied to the outside of the carrier layer at least on one side, preferably on both sides, and/or in that the further layer is applied and/or arranged on the carrier layer over part and/or all of its surface.

10. The construction sheet according to claim 1, wherein the further layer is designed as a, preferably diffusion-tight, metal layer, in particular wherein the metal layer is a metal coating of the carrier layer via metal vapor deposition and/or wherein the metal layer is applied directly to the carrier layer.

11. The construction sheet according to claim 1, wherein the construction sheet and/or the further layer is designed to be slip-resistant on at least one outer side, in particular wherein the slip-resistant surface of the construction sheet and/or the further layer is designed to be roughened and/or rough and/or surface-structured and/or comprises a rough and/or uneven surface structure due to the scatter layer and/or the filler particles.

12. The construction sheet according to claim 1, wherein the construction sheet comprises a low fire load with an energy content below 400 MJ/m², preferably below 200 MJ/m², even more preferably between 1 to 100 MJ/m², even more preferably between 5 to 80 MJ/m² and especially at least substantially less than or equal to 10.5 MJ/m², and/or
in that the carrier layer and/or the further layer and/or the construction sheet is temperature-resistant and/or temperature-stable up to at least 450° C., preferably at least 600° C., even more preferably at least 800° C.

13. The construction sheet according to claim 1, wherein the construction sheet is designed to be resistant against treading, preferably by means of at least one inorganic and/or organic lattice and/or fabric, and/or tear-resistant, preferably by means of a preferably reinforced film layer, in particular one that is vapor- and/or wind-blocking and/or comprises metal and/or plastic and/or consists thereof.

14. The construction sheet according to claim 1, wherein the construction sheet comprises at least on one side, preferably on both sides, on the outside at least one adhesive layer for adhesive bonding, preferably for seam self-adhesion, of neighboring sub-roof sheets,
in particular wherein the adhesive layer is covered with a liner and/or
wherein the adhesive layer is formed over part of the surface, preferably in strip form, and is provided on at least one longitudinal edge of the construction sheet and/or
wherein the adhesive layer extends at least substantially over the entire surface of at least one outer side of the sub-roof sheet and/or
wherein the adhesive layer is flame-retardant or fire-retardant, preferably with a fire resistance class of F30, and/or highly fire-retardant with a fire resistance class F60 according to DIN 4102-2 (as of August 2019) and/or according to EN 13501-2 (as of August 2019).

15. The construction sheet according to claim 1, wherein the construction sheet comprises a monitoring device and/or a monitoring device is associated to the construction sheet, especially wherein the monitoring device comprises at least one measuring device, especially a smoke detector and/or heat detector, for detecting a fire and/or wherein the monitoring device comprises at least one alarm device for emitting an alarm signal.

16. The construction sheet according to claim 1, wherein the carrier layer and/or the further layer and/or the construction sheet is designed to be water-repellent and/or waterproof, preferably with a water column of 0.5 to 50 m, preferably between 0.8 to 40 m, even more preferably between 0.9 to 30 m, and/or
in that the carrier layer and/or the further layer and/or the sub-roofing sheet is designed as a vapor barrier, preferably water vapor retarding with a water vapor diffusion equivalent air layer thickness between 0.5 to 1500 m, preferably between 10 and 1500 m, even more preferably between 100 and 1500 m, and/or is designed as a vapor block, preferably water vapor block with a water vapor diffusion equivalent air layer thickness greater than 1500 m and/or
in that the carrier layer and/or the further layer and/or the building sheet is designed to be open to diffusion, preferably permeable to water vapor, with a water vapor diffusion-equivalent air layer thickness of between 0.01 and 1 m, preferably between 0.02 and 0.5 m, even more preferably between 0.03 and 0.3 m, and in particular at least substantially less than or equal to 5 cm.

17. The construction sheet according to claim 1, wherein the construction sheet comprises at least one, preferably waterproof, functional layer, in particular wherein the functional layer is designed as a microporous membrane layer and/or a monolithic membrane layer and/or wherein the functional layer comprises as material a plastic, preferably based on polyolefinic plastic and/or thermoplastic polyurethane, and/or a polyacrylate, and/or consists thereof.

18. The construction sheet according to claim 1, wherein the further layer has been manufactured in an extrusion process, preferably with a material comprising and/or consisting of, in particular, molten thermoplastic synthetic material, and/or in that the further layer comprises and/or consists of a thermoplastic synthetic material, preferably thermoplastic polyurethane, as material, especially wherein the thermoplastic synthetic material of the further layer has been extruded onto the carrier layer.

19. The use of a construction sheet according to claim 1, wherein a fire-retarding device in a roof structure and/or in a building, preferably for increasing the fire protection of a structure, preferably a pitched roof of the structure, in particular wherein the construction sheet is provided for fire-retarding a fire originating and/or available on the outside of the roof.
